(19) United States
(12) Patent Application Publication
(10) Pub. No.: US 2005/0002742 A1
(43) Pub. Date: Jan. 6, 2005

(54) Method and device for transporting powdery substances

(76) Inventor: Martin Bachmann, Leonberg (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/728,181

(22) Filed: Dec. 4, 2003

(30) Foreign Application Priority Data
Dec. 11, 2002 (DE) 102 57 881.8

(51) Int. Cl. B65G 51/36

(52) U.S. Cl. 406/10

(57) ABSTRACT

In a piston metering pump for supplying the atomizer of a powder coating machine, the vacuum generated in the pump chamber during the suction movement of the piston is reduced in controlled fashion by introducing transport air in order to reduce the powder throughput.

The invention pertains to a method and a device for transporting powdery substances according to the preambles of the independent claims.

The device in question is particularly suitable for use as a powder metering pump for supplying, e.g., the electrostatic atomizer of a powder coating robot or another coating machine in a system for the series coating of workpieces, for example, car bodies. In older systems, the coating powder was usually removed from a container fluidized by means of air with the aid of a vacuum injector according to the Venturi principle and transported to the atomizer in the form of a powder/air mixture via hoses (WO 94/22589). For the reasons cited in DE 101 30 173, it may be more practical to arrange a powder metering pump that operates in accordance with the counterpressure principle directly on the moving machine between the paint changer that moves with the machine and the atomizer.

The metering pump according to DE 101 30 173 essentially consists of a chamber that is connected to a source of compressed air via a controlled valve and to a vacuum source via another controlled valve. The outlet of the chamber is connected to the atomizer while the powder inlet is connected to the outlet of the powder paint changer provided in modern coating machines. The compressed air source and the vacuum source serve as the pump drive. The transport and metering of the coating powder takes place by alternately generating positive and negative pressures in the chamber, in which an air-permeable membrane is arranged for this purpose. The output flow is essentially defined by the chamber size, whereas the throughput can be adjusted by the valve control frequency. In a metering pump of this type, which is known from DE 199 59 473, the valve control is realized by pinching off vacuum and pressure hoses that consist of an elastic material with a shared clamping bar arrangement that is moved cyclically.

In another known pump of the type in question (DDF-Pump Type 0.3 by Ramseier Technologies AG) that operates with two pistons that move in opposite directions and may be more practical for certain applications, the powder throughput per piston stroke is mechanically defined by the displacement of the piston. The throughput can be reduced by reducing the piston stroke, either with a limit stop the can be manually adjusted from the outside or by inserting elastic stroke limiting elements into the cylinder. The mechanical expenditure required for the external adjustment is significant, and the limit stop leads to wear on the pump unit over time. When using internal stroke limiting elements, the throughput can only be varied by replacing the inserted stroke limiting elements with larger or smaller elements. In either instance, an automatically controlled variation of the powder throughput in transport mode is not possible without changing the frequency.

The object of the invention is a method and device of the initially mentioned type which allows a simple, automatically controlled variation of the powder throughput without changing the pump frequency.

This objective is realized with the characteristics of the claims.

The invention is based on the idea that the powder throughput in a powder metering pump of the type in question can be limited by reducing the suction performance.

It is preferred to use a piston metering pump that operates with two oppositely oscillating pistons in order to realize a quasi-continuous delivery and dosing process. According to the invention, the vacuum generated by the piston can be reduced in order to limit the output flow volume by the timed opening of the cylinder, wherein the transport gas for ejecting the powder from the cylinder during the opposite piston movement is preferably introduced into the cylinder through the inlet opening that is separated from the powder inlet. This makes it possible to limit and automatically adjust the powder throughput during transport mode in a particularly simple fashion and without special mechanical aids, e.g., a limit stop. An additional advantage is that the throughput control according to the invention ensures maximum service life of the pump.

The invention is described in greater detail below with reference to the embodiment of a suitable powder metering device for a powder coating robot which is illustrated in the drawing. The drawing shows:

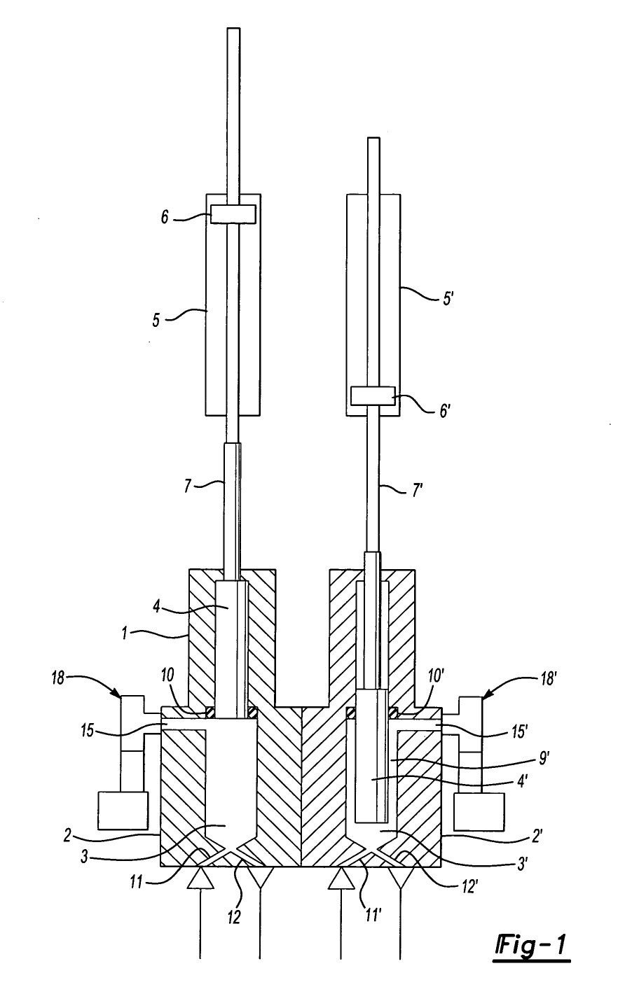

FIG. 1, a schematic sectional representation of a powder metering pump, and

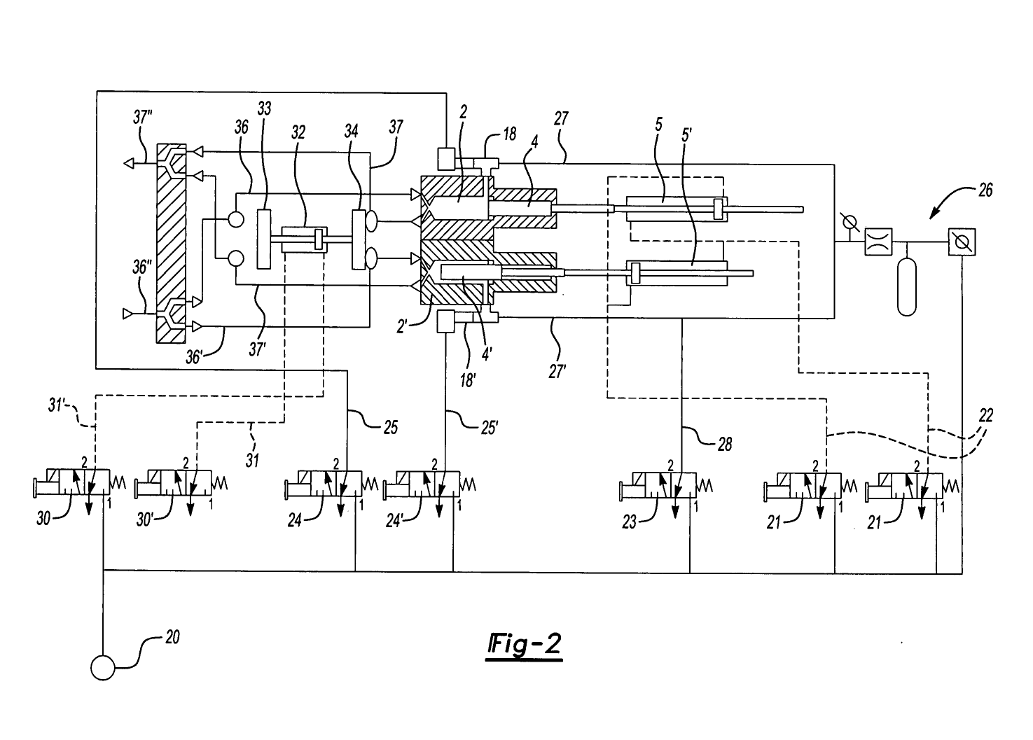

FIG. 2, the pneumatic and valve schematic for the metering pump according to FIG. 1.

The metering pump shown in FIG. 1 contains two oppositely oscillating pistons and operates in accordance with the generally known counterpressure principle. The metering pump contains two cylindrical, parallel pump chambers 3 and 3′ in a common housing 1, where said pump chambers form part of the cylinders 2 and 2′, and pistons 4 and 4′ moved back and forth in said pump chambers. The drive motors for the pistons 4, 4′ may consist of a pneumatic drive cylinder unit 5 and 5′ that is automatically controlled in a conventional manner, wherein said drive cylinder units are attached to the housing 1 and their drive pistons 6 and 6′ are mechanically connected to the given piston 4, 4′, for example, by means of piston rods 7 and 7′.

A gap 9′ in annular form, for example, remains open between the periphery of the piston 4, 4′ and the surrounding inner wall of the pump chamber 3, 3′. In the figure, the upper end of pump chamber 3, 3′ is sealed relative to the adjacent upper part of the cylinder 2, 2′ by an annular piston seal 10, 10′ that surrounds the piston 4, 4′ sliding therein. At the opposite, lower end, each pump chamber 3, 3′ contains a powder inlet 11, 11′ and an outlet 12, 12′. The inlets 11, 11′ are connected to a common line (36″ in FIG. 2) that originates at a reservoir for the coating powder to be transported, and the two outlets 12 and 12′ are connected to a common output line (37″ in FIG. 2) that leads, for example, to the atomizer of the coating robot.

An inlet opening 15 and 15′ for the transport air (or another transport gas) of the powder to be transported respectively leads to the pump chamber 3, 3′, in particular, directly adjacent to the piston seal 10, 10′. Except for the inlet opening 15, 15′, the inlet 11, 11′ and the outlet 12, 12′ that are respectively controlled by valves described below, the two pump chambers 3, 3′ are respectively hermetically sealed by the housing 1 and the seals 10, 10′.

The pump described thus far and its operating principle correspond to the initially cited DDF pump. For example, when the piston 4 moves up in the cylinder 2, it generates a vacuum in the pump chamber 3 such that the powder (which, if applicable, is fluidized by means of air) is drawn into the chamber through the inlet 11. During this process, the outlet 12 of the pump chamber 3 is closed by the corresponding valve (FIG. 2). The piston 4′ simultaneously moves down in the other pump chamber 3′. Compressed air flows into the chamber 4′ [sic; 3′] through the inlet opening 15′ that is opened during this time by the corresponding valve, such that the powder injection that was previously drawn into this chamber is ejected through the outlet 12′ opened by the corresponding valve. During the downward movement of the piston 4′, transport air arriving from the inlet opening 15′ is able to flow to the outlet 12′ along the piston through the aforementioned gap 9′. Since the powder should not be compressed by the piston, the inlet openings 15 and 15′ are opened in a timely manner before the piston movement such that the pump chamber is already entirely or partially emptied by the transport air during the downward movement of the piston.

During the described operation of the pump, the powder throughput per piston stroke is mechanically defined by the displacement of the piston. According to the invention, the piston displacement and the respective throughput is limited or changed by reducing the vacuum generated during the suction movement of the piston to the desired extent by the timed introduction of transport air (which normally serves for transporting the powder from the ejection cylinder). Due to the weaker vacuum, a correspondingly reduced quantity of powder is drawn into the pump chamber such that the throughput of the pump is reduced. Here, the vacuum can be adjusted between a given maximum value, at which the air inlet opening is closed, and a complete closing off of the suction effect, and thus the powder transport can be adjusted as a function of the quantity of transport air introduced. The transport air that reduces the vacuum and consequently the powder throughput preferably can be automatically determined and controlled during the coating operation by the opening time and/or the opening width of the transport air valves 18 and 18′.

In certain instances, e.g., when refilling containers, the pump can be operated at maximum throughput in order to reduce the refilling time. Once a predetermined powder weight is reached during the refilling process, it may be practical to reduce the throughput of the pump with the aid of the transport air valve at the end of the refilling time, for example, in order to adjust a precise mixing ratio between fresh powder and recycling powder.

The invention can be realized exclusively by means of signal control and requires no mechanical manipulations or other additional expenditures because the required transport air valves are provided in any case. A practical pneumatic and valve schematic for the metering pump according to FIG. 1 is shown in FIG. 2.

The pneumatic drive cylinder units 5, 5′ are conventionally supplied by a compressed air source 20 via control valves 21 and lines 22. A pneumatic drive of the pump may be practical for electrostatic atomizers, e.g., for safety reasons, although both pistons 4, 4′ of the delivery cylinders may also be driven hydraulically or electrically. The quantity of powder being transported can be adjusted by controlling the variable change-over frequencies of the valves 21.

The transport air of both cylinders 2 and 2′ is controlled by means of the control valves 24 and 24′ that are also connected to the compressed air source 20 and change over the valves 18 and 18′ via pneumatic control lines 25 and 25′, respectively. The valves 18, 18′ may consist, for example, of 2/2-way valves attached to the housing 1 of the pump. The transport air is supplied to the valves 18, 18′ and consequently the cylinders 2, 2′ via an adjustable pressure throttle device 26 and the lines 27, 27′, respectively. A line 28 that is connected to the lines 27, 27′ and provided for cleaning purposes is also supplied by the compressed air source 20 via another control valve 23.

Supply lines 31 and 31′ for the pneumatic drive cylinder unit 32 of a pinch-off valve arrangement are also connected to the common compressed air source 20 via the control valves 30 and 30′, wherein the pinch-off valve arrangement comprises two mechanically connected clamping bars 33, 34 that cyclically open and close elastic powder hoses at the inlets and outlets (11, 11′, 12, 12′ in FIG. 1) of the pump in accordance with the principle described in DE 199 59 473. According to the figures, the clamping bar 33 controls the input hose 36 of the cylinder 2 and the output hose 37′ of the cylinder 2′, wherein the other clamping bar 34 controls the input hose 36′ and the output hose 37 of the cylinder 2. In the position shown, the clamping bar 34 closes the hoses 37 and 36′ during the suction movement of the piston 4 while the hoses 36 and 37′ are opened during this time. This situation is reversed during the suction movement of the piston 4′. The two input hoses 36 and 36′ are connected to a common input line 36″, and the two output hoses 37, 37′ are connected to the output line 37″.

The entire transport system is automatically controlled by the master program control system of the coating system which is able to switch the valves 21, 23, 24, 24′, 30 and 30′ by means of electronic signals.

The invention is not limited to the described embodiment. For example, it would also be possible to realize other powder metering pumps, in which the powder is drawn in with negative pressure and ejected with positive pressure.

1. (Cancelled)

2. (Cancelled)

3. (Cancelled)

4. (Cancelled)

5. (Cancelled)

6. (Cancelled)

7. (Cancelled)

8. (Cancelled)

9. (Cancelled)

10. (Cancelled)

11. (Cancelled)

12. (Cancelled)

13. (Cancelled)

14. (Cancelled)

15. (Cancelled)

16. (Cancelled)

17. (Cancelled)

18. (Cancelled)

19. An apparatus for moving powder comprising:
a housing defining a chamber with a first powder inlet piercing said chamber and a first powder outlet piercing said chamber and a first inlet opening piercing said chamber and spaced from said first powder inlet and said first powder outlet;
a piston moveable in said chamber and having an outer diameter; and
a valve positioned adjacent said first inlet opening and moveable between an open position and closed position to selectively open and close said first inlet opening.

20. The apparatus of claim 19 wherein said chamber includes a first portion defining a first inner diameter and a second portion defining a second inner diameter wherein the first inner diameter is greater than said second inner diameter and said second inner diameter substantially corresponds to said outer diameter of said piston and an air passageway is defined between said outer diameter of said piston and said first inner diameter of said first portion.

21. The apparatus of claim 20 wherein said first powder inlet and said first powder outlet and said first inlet opening are defined by said first portion of said chamber.

22. The apparatus of claim 21 including a first drive unit operably associated with said piston to move said piston between said first and second portions of said chamber.

23. The apparatus of claim 22 including a controller controlling said first drive unit and said valve.

24. The apparatus of claim 19 including a reservoir of compressed air in fluid communication with said valve wherein an air stream is moveable from said reservoir to said first portion of said cylinder when said valve is in said open position.

25. The apparatus of claim 24 including a throttle device disposed in between said reservoir and said valve wherein said throttle device being operable to adjust a pressure of said air stream.

26. The apparatus of claim 19 wherein said valve is moveable to a plurality of positions between said open and closed positions.

27. A method for moving powder comprising the steps of:
defining a chamber with a housing wherein a first powder inlet piercing said chamber and a first powder outlet piercing said chamber and a first inlet opening piercing said chamber and spaced from said first powder inlet and said first powder outlet;
moving a piston having an outer diameter in said chamber; and
position a valve adjacent said first inlet opening wherein said valve being moveable between an open position and closed position to selectively open and close said first inlet opening.

28. The method of claim 27 including selectively directing an air stream to the first inlet opening.

29. The method of claim 28 wherein the selectively directing step is further defined as opening the valve to pass the air stream through the first inlet opening during the moving step.

30. The method of claim 29 wherein the selectively directing step is further defined as opening the valve to pass the air stream through the first inlet opening during the moving step when the piston is moving away from the first powder inlet.

31. The method of claim 29 wherein the selectively directing step is further defined as opening the valve to pass the air stream through the first inlet opening during the moving step when the piston is moving toward the first powder inlet.

32. The method of claim 27 including controlling a rate of the air stream with a throttle device positioned upstream of the valve.

33. The method of claim 27 including the steps of:
defining a second chamber with the housing wherein a second powder inlet piercing said second chamber and a second powder outlet piercing said second chamber and a second inlet opening piercing said second chamber and spaced from said second powder inlet and said second powder outlet;
moving a second piston having an outer diameter in said second chamber; and
position a second valve adjacent said second inlet opening wherein said second valve being moveable between an open position and closed position to selectively open and close said second inlet opening.

34. The method of claim 33 including moving the piston and the second piston in opposite directions with respect to one another.

35. The method of claim 33 including the steps of:
drawing powder into one of the first and second chambers; and
ejecting powder from the other of the first and second chambers during the drawing step.

36. The method claim 33 including concurrently closing the first powder inlet and the second powder outlet.

37. The method of claim 33 including arranging the first and second chambers in parallel with respect to one another.
